(19) United States
(12) Patent Application Publication
(10) Pub. No.: US 2005/0029001 A1
(43) Pub. Date: Feb. 10, 2005

(54) Molded electric device and method for making molded electric device

(75) Inventors: Junichi Sato, Kanagawa-ken (JP); Osamu Sakaguchi, Tokyo (JP); Masaru Miyagawa, Tokyo (JP); Satoshi Makishima, Tokyo (JP); Susumu Kinoshita, Tokyo (JP)

Correspondence Address: FOLEY AND LARDNER;SUITE 500, 3000 K STREET NW, WASHINGTON, DC, 20007, US

(73) Assignee: KABUSHIKI KAISHA TOSHIBA

(21) Appl. No.: 10/895,992

(22) Filed: Jul. 22, 2004

(30) Foreign Application Priority Data
Jul. 25, 2003 (JP) 2003-202128

(51) Int. Cl. H02G 3/08

(52) U.S. Cl. 174/50

(57) ABSTRACT

A molded electric device having an insulated casing made of ceramics that has higher dielectric strength. The molded electric device includes an insulated casing, an endplate, an electric component and an electric insulating layer. The insulated casing is made of ceramics and has an end and an unglazed outer surface. The endplate is fitted to the end of the insulated casing. The electric component is accommodated in the insulated casing by the endplate. The electric insulating layer is molded to the unglazed outer surface of the insulated casing.

### CROSS-REFERENCE TO RELATED PATENT APPLICATIONS

This application is based upon and claims the benefit of priority from prior Japanese Patent Application No. 2003-202128 filed on Jul. 25, 2003, the entire contents of which are incorporated herein by reference.

### FIELD OF THE INVENTION

This invention relates generally to a molded electric device like a vacuum circuit breaker that is molded of epoxy resin, and in particular a molded electric device with improved dielectric strength.

### BACKGROUND OF THE INVENTION

Conventionally, an electric device such as a vacuum circuit breaker has its outer surface molded by an insulating material like an epoxy resin. This helps to prevent weakening of its dielectric strength because an outer surface of the electric device is not affected by moisture contamination. In other words, an electric insulating layer is molded and formed on an outer surface of the electric device to prevent weakening its dielectric strength. It is generally known that an epoxy resin itself does not have sufficient toughness. Therefore, silane finished particles, such as powdered silicon, alumina (aluminum oxides), or glasses, are mixed with the epoxy resin and used as the insulating material to improve toughness of the insulating layer. Usually, a silane coupling agent is used for a silane finishing to improve an adhesive property of the powdered particles.

Furthermore, an electric device like a vacuum circuit breaker has an insulated casing made of ceramics such as alumina ceramics. Conventionally, an outer surface of the insulated casing such an electric device is coated (glazed) by a vitreous glaze to prevent the outer surface from being stained. The vitreous glaze is sprayed on the outer surface as a powdered vitreous material solution. After spraying the powdered vitreous material solution on the outer surface, the outer surface is heated to a high temperature so as to form a glaze layer on the outer surface.

The spraying of the powdered vitreous material solution may cause internal bubbles inside when it is sprayed on the outer surface of the insulated casing. These bubbles form as cavities in the glaze layer or on a boundary of the surface and the glaze layer. The cavities, which are formed in the glaze layer or on the boundary of the insulated casing and the glaze layer, may cause a partial discharge even when the electric insulating layer is molded without voids. It may cause a dielectric defect and result in a weakening of the dielectric strength.

The insulating layer, which may be the epoxy resin mixed with the silane finished particles, are molded on the outer surface of the insulated casing. Silane finishing can improve the adhesive property of an epoxy resin mixture. However, separations are formed along the boundary between the glaze layer and the insulating layer during a cooling process of the insulating layer due to the difference of a rate of expansion. The separations along the boundary portion between the glaze layer and the insulating layer may cause a fracture of insulation that causes a partial discharge, and result in a deterioration of insulation performance. Therefore, a conventional electric device such as a vacuum circuit breaker has the insulated layer with a larger thickness on the outer surface of the insulated casing so as to weaken an electric field strength which is applied to the insulated casing. This results in enlarging a size of the electric device.

### SUMMARY OF THE INVENTION

Accordingly, an advantage of an aspect of the present invention is to provide a molded electric device having an insulated casing made of ceramics that has higher dielectric strength.

To achieve the above and other advantages, one aspect of the present invention provides a molded electric device that comprises an insulated casing made of ceramics, having an end and an unglazed outer surface, an endplate fitted to the end of the insulated casing, an electric component accommodated in the insulated casing by the endplate, and an electric insulating layer molded to the unglazed outer surface of the insulated casing.

Another aspect of the present invention provides a method for making a molded electric device that comprises the steps of providing an insulated casing made of ceramics, providing an electric component which is accommodated inside the insulated casing, accommodating the electric component inside the insulated casing by an endplate, and molding the outside of the insulated casing without glazing the outer surface of the insulated casing.

Further features, aspects and advantages of the present invention will become apparent from the detailed description of various embodiments that follows, when considered together with the accompanying figures.

### BRIEF DESCRIPTION OF THE DRAWINGS

FIG. 1 is a sectional view showing a molded electric device according to one embodiment.

FIG. 2 is a an enlarged sectional view showing a boundary portion between the insulated casing and the insulating layer of a modified molded electric device according to the embodiment.

FIG. 3 is a schematic half sectional diagram showing the experimental model that was used to investigate the dielectric strength.

FIG. 4 is a comparison chart of the investigations showing the lowest start and end voltage of partial discharge.

### DETAILED DESCRIPTION OF THE PREFERRED EMBODIMENTS

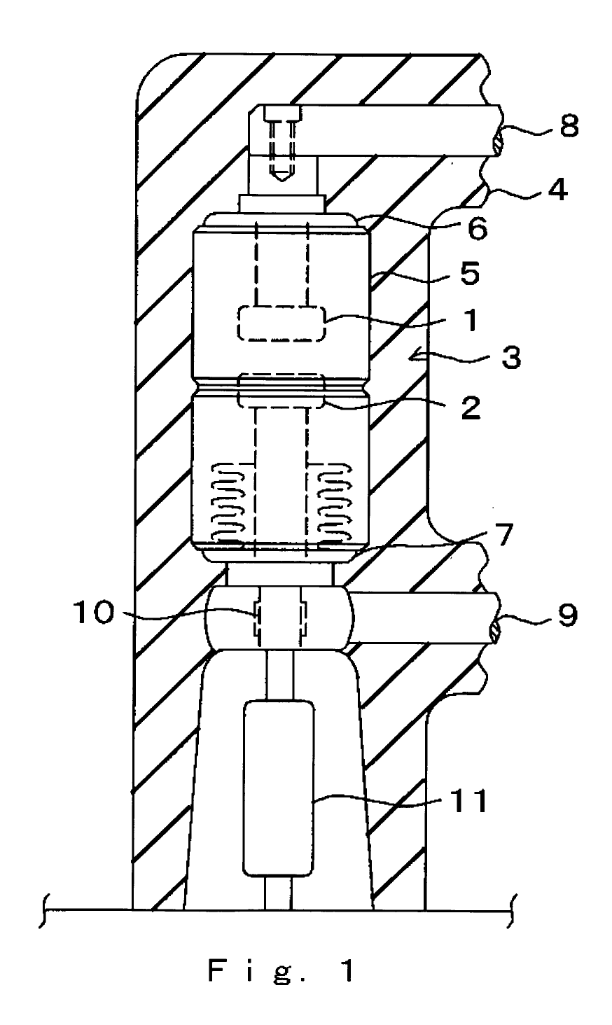

An embodiment of a molded electric device in accordance with the present invention will be explained with reference to FIGS. 1 to 3. FIG. 1 is a sectional view showing a molded electric device having an insulated casing with an insulating layer as a molding according to the embodiment. In FIG. 1, a vacuum circuit breaker is provided as one example of the molded electric device, and an epoxy resin is applied as the insulating layer molded on the outer surface of the insulated casing of the vacuum circuit breaker.

As shown in FIG. 1, a vacuum circuit breaker 3, as an electric device, includes contact points 1 and 2, an insulated casing 5, an insulating layer 4, and sealing metals 6 and 7. It should be understood that FIG. 1 is exemplary only and does not limit the invention. One skilled in the art would recognize various alternatives and/or modifications which are considered part of the invention. Insulated casing 5 is made of ceramics such as alumina (aluminum oxide) ceramics and has, for example, a cylindrical shape. Contact points 1 and 2, as electrical components, are accommodated in the insulated casing 5, with the contact points 1 and 2 being detachable from the other. Sealing metals 6 and 7, as endplates, are fitted to each ends of insulated casing 5, and substantially hold the contact points 1 and 2. Further, the sealing metals 6, 7 and bellows seal the insulated casing 5 and keep the inside of insulated casing 5 in a vacuum.

Contact point 1 and 2 constitute electric components, which are accommodated inside the insulated casing 5 by sealing metals 6 and 7. Contact point 2 is physically connected to a movable shaft 10. To the movable shaft 10, a operational mechanism (not shown) is connected through an operation rod 11 to open and close the contact points 1 and 2. A fixed side conductor 8, which is a part of circuitry, is electrically connected to contact point 1 from one end of insulated casing 5. A movable side conductor 9 is electrically connected to contact point 2.

An insulating layer 4 is formed surrounding the vacuum circuit breaker 3 by molding an insulating material made of an epoxy resin. An outer surface of the insulated casing 5 is a naked (unglazed) ceramic surface, which means a glaze is not applied to the outer surface.

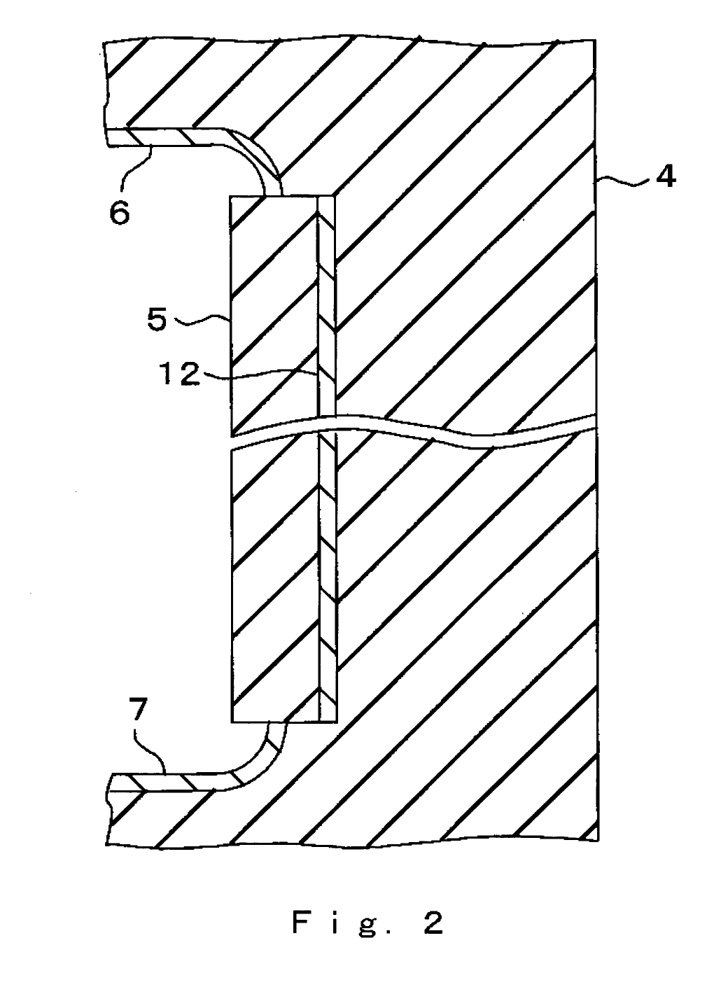

FIG. 2 is a an enlarged sectional view showing a boundary portion between the insulated casing 5 and the insulating layer 4 of a modified molded electric device according to the embodiment. The same symbols are used for the same elements shown in FIG. 1, and detailed descriptions are omitted for those elements.

In this modification, a silane coupling agent layer 12 is formed between the insulating layer 4 and the unglazed outer surface of the insulated casing 5. Silane coupling agent layer 12 is formed by putting (coating) a silane coupling agent on the unglazed outer surface of insulated casing 5 before molding the insulated casing 5. The silane coupling agent includes an organic substance and silicon. More precisely, in one embodiment, silane coupling agent layer 12 is formed as below.

Firstly, vacuum circuit breaker 3 having insulated casing 5, which is made of ceramics, is prepared. As mentioned above, the outer surface of insulated casing 5 is remained as naked (unglazed) surface. The naked outer surface of insulated casing 5 may be obtained, for example, by removing glaze by means of sandblasting.

After preparing vacuum circuit breaker 3 having an unglazed surface of insulated casing 5, the liquid silane coupling agent is coated on the unglazed surface, for example, by using a brush so as not to cause coating irregularity. In the case of the viscosity of the liquid silane coupling agent being high, the liquid silane coupling agent may be diluted with a treatment agent. The treatment agent may be obtained by mixing water and alcohol. The liquid silane coupling diluent, which is a liquid silane coupling agent diluted by the treatment agent, may lower the viscosity. Further, with the liquid silane coupling diluent, the wettability is improved, and coating operation may be easily performed. Furthermore, owing to hydrolysis of the treatment agent, the adhesiveness with the epoxy resin may be improved when using the liquid silane coupling diluent.

Vacuum circuit breaker 3 coated with the silane coupling agent is set in a metal mold for forming an insulating layer 4. The metal mold with vacuum circuit breaker 3 is heated to a predetermined temperature, and the epoxy resin is injected in the metal mold. After the epoxy resin is cured and become the insulating layer 4, the silane coupling agent layer 12 is formed at a boundary portion between insulated casing 5 and insulating layer 4. Silane finished particles, such as powdered silicon, alumina (aluminum oxides), or glasses, may be mixed with the epoxy resin as filler and may be used with a material of the insulating layer 4 to improve toughness of insulating layer 4. The toughness of insulating layer 4 may be further improved by using inorganic particles, such as powdered silicon, having at least two kind of particle size mixed up with rubber particles having a core-shell structure, as filler of the epoxy resin.

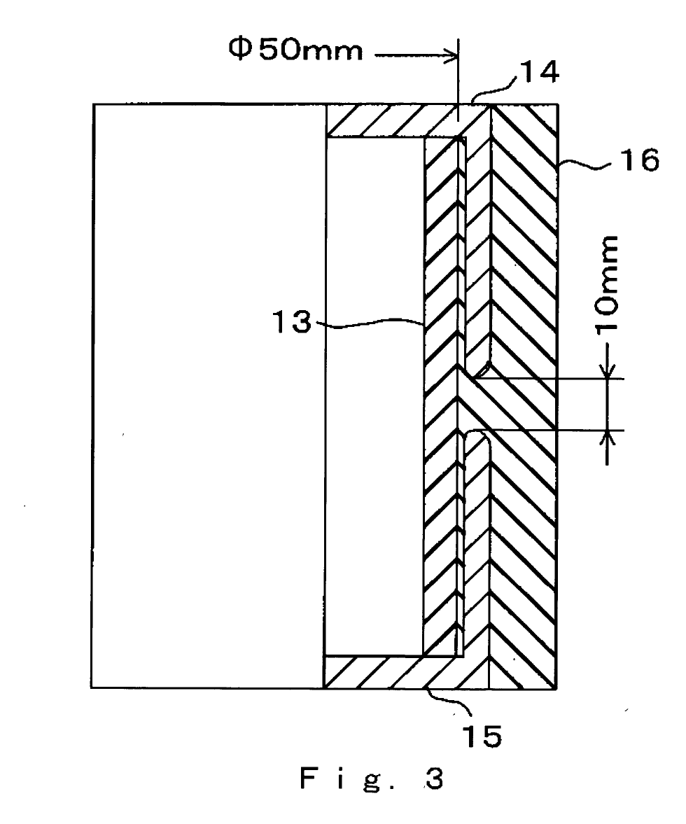

The dielectric strength of the molded electric devices according to the embodiment above was investigated with the partial discharge characteristic by using an experimental model. FIG. 3 is a schematic half sectional diagram showing the experimental model that is used to investigate the dielectric strength at the boundary portion between the insulated casing and the insulating layer of the electric device according to the embodiment.

As shown in FIG. 3, the experimental model used in the investigation is an insulated casing 13 whose diameter Φ is 50 mm. A pair of ring-like electrodes 14 and 15 is disposed so as to surround insulated casing 13 with tip ends thereof separated by 10 mm. Electrodes 14 and 15 simulate the sealing metals 6 and 7 of the vacuum circuit breaker 3 shown in FIGS. 1 and 2. The outer surface of insulated casing 13 is molded by an epoxy resin without glazing the outer surface of insulated casing 13. Circumferential side of electrodes 14 and 15 is also molded in the epoxy resin but each end of electrodes 14 and 15 is exposed. Epoxy resin is formed as insulating layer 16, which simulates the insulated layer 4 shown in FIGS. 1 and 2. With this experimental model, the partial discharge characteristics at the boundary portion between the insulating casing 13 and the insulating layer 16 was obtained by applying a voltage to one electrode 14 (15) with the other electrode 15 (14) being grounded.

The investigations were conducted in three conditions, Example 1, Example 2, and comparative example. Examples 1 and 2 are based upon the embodiment discussed herein, which has insulated casing with an unglazed outer surface.

Example 1 has no silane coupling agent layer in the boundary portion between insulated casing 13 and insulating layer 16, which simulates the configuration shown in FIG. 1. On the other hand, Example 2 has silane coupling agent layer in the boundary portion between insulated casing 13 and insulating layer 16, which simulates the configuration shown in FIG. 2.

Comparative example has insulated casing 13 with glazed outer surface, which represents the conventional art. Comparative example has no silane coupling agent layer in the boundary portion between the insulated casing 13 and insulating layer 16.

Three samples of the experimental models is made for each of Examples 1, 2 and Comparative example. The investigations of start and end voltages of partial discharge were conducted three times for each example.

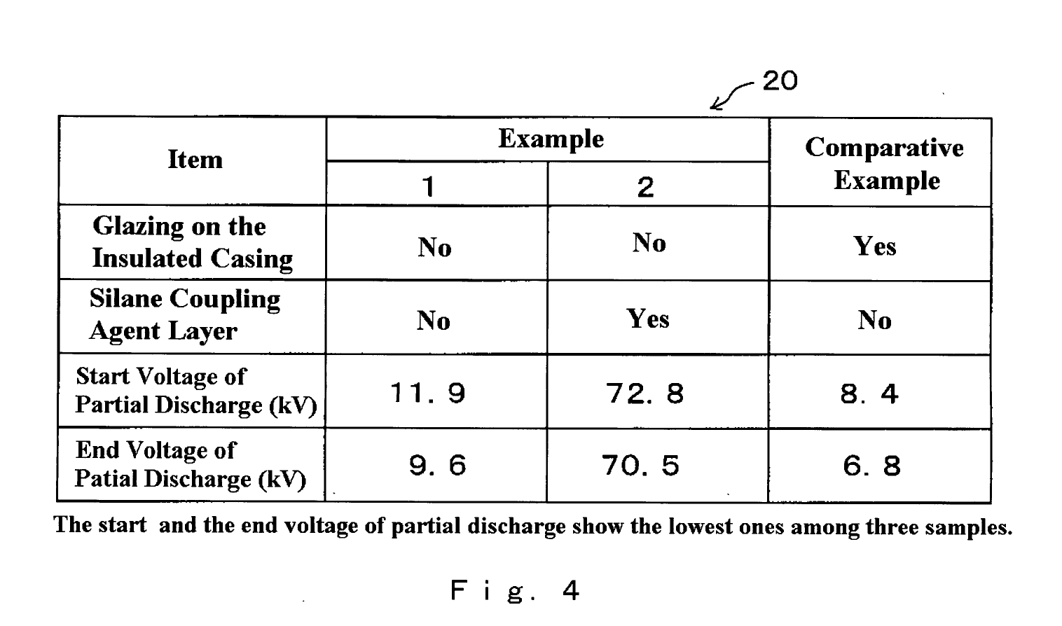

The result of the investigation is shown in FIG. 4, which is a comparison chart of the investigations showing the lowest start and end voltage of partial discharge out of three investigations for each example.

As shown in FIG. 4, each row of a table 20 indicates the condition and result for each example mentioned above.

Example 1 is improved by a substantial 1.4 times in the partial discharge characteristics of the start voltage of partial discharge and end voltage of partial discharge in comparison with that of Comparative example. Furthermore, Example 2 is improved by a substantial 9 times relative to Comparative example.

After the investigation of the partial discharge characteristics, the experimental models were disassembled and investigated. In Example 1, separations or cavities, which are considered as defects could not be confirmed at a boundary between ceramics of the insulated casing 13 and the insulating layer 16. Furthermore, in Example 2, the ceramics of the insulated casing 13 and the insulating layer 16 were strongly adhered through the silane coupling agent layer. In Comparative example, some cavities were found at a boundary between ceramics and the glaze.

As described above, in the molded electric device according to an embodiment of the invention, since a surface of the insulated casing 5 of the vacuum circuit breaker 3 is made of a naked (unglazed) ceramic surface, the partial discharge due to cavities in the glaze may not be formed, and thereby the dielectric strength can be improved.

Further, the silane coupling agent is coated on the naked ceramic surface so as to form the silane coupling agent layer between the insulated casing and the insulating layer, the adhesiveness with the insulating layer is improved, and thereby the dielectric strength may be further improved.

It is also noted that a conductive paint, such as silver paint, is coated on a surface of each of the sealing metals as the endplates, the adhesiveness between the insulating layer and each of the sealing metals can be improved, resulting in further improving the partial discharge characteristics and dielectric strength.

The present invention is not restricted to an above embodiment. In the embodiment of the invention, the molded electric device was explained with a vacuum circuit breaker; however, the invention can be applied also to an electric device in which an electric component such as a thyristor element or a zinc oxide element is accommodated in a ceramic cylindrical insulated casing. In those cases, the endplate may not be a plate, but having a structure that can hold the electric component inside the insulated casing. Those structure may be easily obtained by one of ordinary skill in the art.

Other embodiments of the present invention will be apparent to those skilled in the art from consideration of the specification and practice of the invention disclosed herein. It is intended that the specification and embodiments be considered as exemplary only, with a true scope and spirit of the invention being indicated by the following claims.

1. A molded electric device, comprising:
an insulated casing made of ceramics, having an end and an unglazed outer surface;
an endplate fitted to the end of the insulated casing;
an electric component accommodated in the insulated casing by the endplate; and
an electric insulating layer molded to the unglazed outer surface of the insulated casing.

2. A molded electric device according to claim 1,
wherein the electric insulating layer comprises epoxy resin.

3. A molded electric device according to claim 1, further comprising:
a silane coupling agent layer formed between the electric insulating layer and the unglazed outer surface of the insulated casing.

4. A molded electric device according to claim 1, further comprising:
a conductive coating layer formed between the electric insulating layer and an outer surface of the endplate.

5. A molded electric device according to claim 1,
wherein the molded electric device comprises a vacuum circuit breaker.

6. A method for making a molded electric device, comprising:
providing an insulated casing made of ceramics;
providing an electric component, which is accommodated inside the insulated casing;
accommodating the electric component inside the insulated casing by an endplate, and,
molding outside of the insulated casing without glazing an outer surface of the insulated casing.

7. A method for making a molded electric device according to claim 5, further comprising:
providing a silane coupling agent layer on the outer surface of the insulated casing before molding the insulated casing.

8. A method for making a molded electric device according to claim 6, further comprising:
providing a diluent by mixing water and alcohol, and
diluting the silane coupling agent with the diluent before providing the silane coupling agent layer on the outer surface of the insulated casing.
